(19) United States
(12) Patent Application Publication
(10) Pub. No.: US 2026/0371262 A1
(43) Pub. Date: Nov. 19, 2026

(54) DYNAMIC POWER MODE SWITCHING IN WIRELESS LOCAL AREA NETWORKS

(71) Applicant: QUALCOMM Incorporated, San Diego, CA (US)

(72) Inventors: Sri Chaitanya CHALAMACHARLA, Hyderabad (IN); Mallikarjuna AKULA, Wanaparthy (IN); Hemant Kumar SAHOO, Hyderabad (IN); Shailendra Pratap SINGH, Hyderabad (IN)

(21) Appl. No.: 19/210,980

(22) Filed: May 16, 2025

(51) Int. Cl. H04W 52/36; H04W 8/22; H04W 60/04

(52) U.S. Cl. CPC H04W 52/367; H04W 8/22; H04W 60/04

(57) ABSTRACT

This disclosure provides systems and methods for enabling dynamic power mode switching in wireless communication devices operating in the 6 GHz frequency band. A wireless device associated with an access point (AP) supporting composite power mode operation can dynamically transition between transmission power modes, such as Low Power Indoor (LPI), Very Low Power (VLP), and Standard Power (SP), without requiring reassociation. The device initiates the switching procedure by transmitting an action frame identifying the new power mode and relevant transmission constraints. The AP can process the action frame and adjust communication parameters accordingly to allow power mode transitions. In some examples, the transition can be based on operating conditions, including signal strength, usage environment, and device-specific requirements. The action frame may include one or more fields that specify information such as minimum and maximum transmit power levels, time-of-day constraints, and channel availability.

### TECHNICAL FIELD

This disclosure relates generally to wireless communication and, more specifically, to dynamic power mode switching in client devices operating in wireless local area networks (WLANs), such as Wi-Fi 6E and 6 GHz networks.

### DESCRIPTION OF THE RELATED TECHNOLOGY

Wireless communication networks may include various types of wireless communication devices, including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols, or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device. The wireless communication device includes a processing system that includes one or more processors and one or more memories coupled with the one or more processors, the processing system configured to cause the wireless communication device to provide an association request frame that includes an indication for power mode switching to an access point (AP) supporting composite power mode operation, receive an association response frame advertising a composite power mode capability from the AP, provide an action frame including an indication of a new power mode at the wireless communication device and associated transmission power constraints to the AP, and switch operation of the wireless communication device to the new power mode while maintaining an association with the AP.

In some examples, the techniques described relate to the wireless communication device where the association response frame includes one or more information fields respectively corresponding to a low power indoor (LPI) mode, a very low power (VLP) mode, and a standard power (SP) mode.

Another innovative aspect of the subject matter described in this disclosure can be implemented in an AP. The AP includes a processing system that includes one or more processors and one or more memories coupled with the one or more processors, the processing system configured to cause the AP to receive, from a wireless communication device, an association request frame including an indication of support for dynamic power mode switching, provide an association response frame indicating availability of composite power mode operation, receive, from the wireless communication device, an action frame indicating a new power mode, and communicate with the wireless communication device in accordance with the new power mode while maintaining an association with the wireless communication device.

Another innovative aspect of the subject matter described in this disclosure can be implemented in an application client device. The application client device includes a processing system that includes one or more processors and one or more memories coupled with the one or more processors, the processing system configured to cause the application client device to provide an association request frame that includes an indication for power mode switching to an AP supporting composite power mode operation, receive an association response frame advertising a composite power mode capability from the AP, provide an action frame including an indication of a new power mode at the application client device and associated transmission power constraints to the AP, and switch operation of the application client device to the new power mode while maintaining an association with the AP.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of an example access point communicating with devices in various device classes.

FIG. 3 shows a pictorial diagram of example device classes with associated power modes in communication with access points.

FIG. 4 shows a pictorial diagram of an example wireless communication system with traffic flow between a wireless communication device and an access point participating in a power mode switching operation.

FIG. 5 shows an example flowchart illustrating an example process performable by or at a wireless communication device that supports power mode switching while maintaining an association with an access point.

FIG. 6 shows an example flowchart illustrating an example process performable by or at an access point that supports power mode switching while maintaining an association with a wireless communication device.

FIG. 7 shows an example block diagram of an example wireless communication device that supports power mode switching while maintaining an association with an access point.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Various aspects relate generally to wireless communication and, more specifically, to dynamic power mode switching between linked wireless devices operating in the 6 GHz frequency band. Some aspects more specifically relate to techniques for enabling client devices to dynamically transition between transmission power modes (such as Low Power Indoor (LPI), Very Low Power (VLP), and Standard Power (SP)) when associated with access points (APs) supporting composite power mode operation, without requiring reassociation.

In some aspects, a wireless station transmits an association request frame, including an indication of support for dynamic power mode switching. The access point responds with an association response frame confirming its composite mode capabilities. Once associated, the wireless station may implement a change to power modes based on one or more operating conditions, such as regulatory requirements, thermal thresholds, or specific absorption rate (SAR) limits. In response, the wireless station transmits an action frame indicating a new power mode and optionally includes transmission constraints related to the selected mode. The AP processes the action frame and updates communication parameters with the wireless station without requiring reassociation.

In some examples, the wireless station receives an indication of the AP's composite power mode capabilities in a beacon frame prior to association. In some other examples, the action frame enables the AP to configure wireless communication parameters specific to the new mode. The wireless station may adjust internal radio subsystem parameters based on transmission constraints applicable to the new power mode. Dynamic power mode switching can occur at any time during an active association and is handled entirely over the air, enabling real-time power mode transitions that align with compliance and safety considerations.

Particular aspects of the subject matter described in this disclosure can be implemented to realize one or more of the following potential advantages. Dynamic 6 GHz power mode switching can enable client devices to seamlessly transition between different power modes (LPI, VLP, SP) without disconnecting or reassociation, which can reduce network downtime and optimize connectivity performance. Unlike traditional implementations where a client device is locked to a single power mode after association, the proposed solution provides flexibility in power mode selection based on real-time transmission needs, SAR compliance, and regulatory limitations.

For example, a client device operating in an indoor environment may initially be associated with an AP in LPI mode but later switch to VLP mode for outdoor transmissions without reassociation. Similarly, a device may shift to SP mode for high-power transmissions when needed while ensuring compliance with SAR safety thresholds. The ability to dynamically switch power modes can enable improved energy efficiency, as devices can adapt transmission power based on proximity to the AP, reducing unnecessary high-power transmissions.

In some aspects, the client device can avoid service interruptions and enhance user experience by eliminating the need for repeated reconnections when changing power modes. This results in faster and more reliable 6 GHz connectivity, improved spectrum utilization, and better overall network performance for client devices in varying operational conditions.

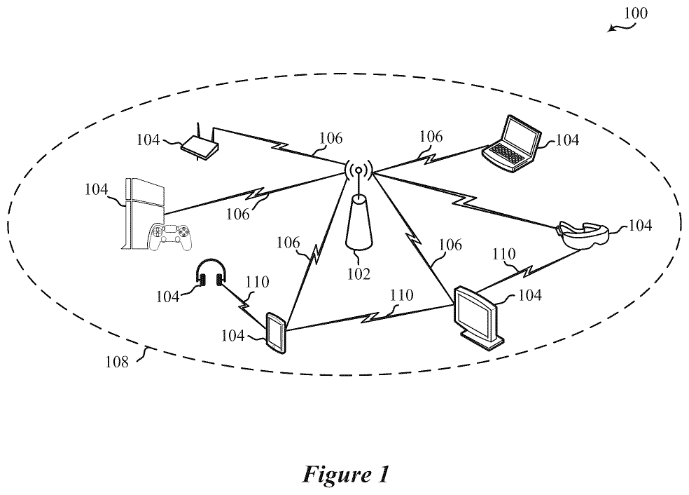

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”), including the BSSID, to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS), including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network, such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or, the STAs 104, or both may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network, enabling communication with the two or more peripheral devices. Additionally, the AP 102 and STAs 104 may support additional ULL applications, such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control, and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of the spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be, and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend, and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel, and one or more additional second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices, and an O-Primary channel may be specifically used by non-legacy (for example, UHR-or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

Some processes, methods, operations, techniques, or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. For example, an AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent of signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

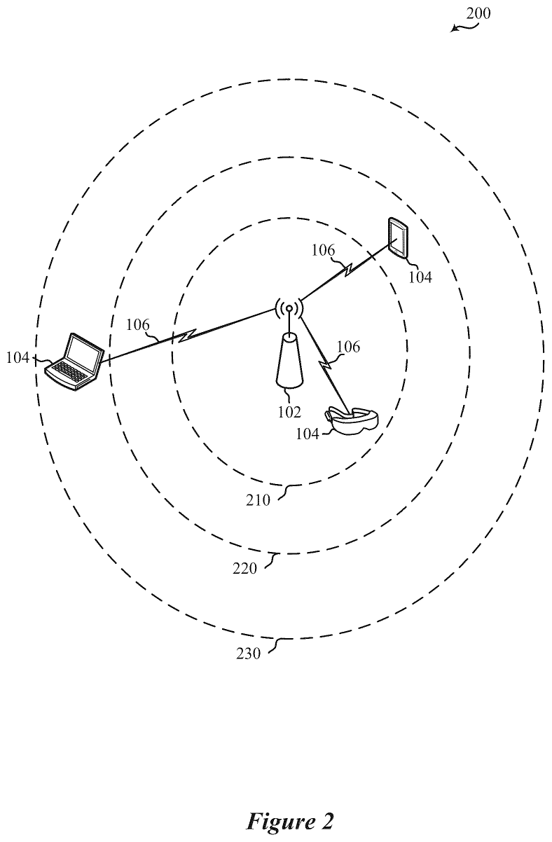

FIG. 2 shows a pictorial diagram of an example wireless communication environment 200 in which an AP 102 is configured to concurrently manage wireless communication sessions with multiple classes of client devices operating under different regulatory power classifications. These include Very Low Power (VLP) devices 210, Low Power Indoor (LPI) devices 220, and Standard Power (SP) devices 230. Each device class corresponds to distinct transmission capabilities and operational constraints governed by regional spectrum regulations, particularly relevant in 6 GHz bands. The AP 102 may function as a multi-link or multi-band access node, capable of maintaining simultaneous connections across segregated basic service sets (BSSs), each aligned to a specific power class. These BSSs may be virtualized or physically partitioned to ensure coexistence, manage interference and optimize throughput.

The VLP devices 210 can represent battery-sensitive and mobile applications such as wearables, IoT sensors, and augmented reality peripherals. These devices can operate under power limitations and are generally supported through narrowband or low-duty-cycle transmission schedules. Communication with VLP devices may be optimized using power-aware polling intervals and sleep-aware access policies. In contrast, the LPI devices 220 represent a broader range of indoor client devices such as tablets, laptops, smart televisions, and mesh nodes. These devices can operate at moderate transmission powers and benefit from wider channel allocations (such as 80 MHz or 160 MHz in the 6 GHz band). The AP 102 may enable high-throughput features such as spatial multiplexing and OFDMA, particularly when coordinating traffic among multiple LPI devices in dense indoor deployments.

The SP devices 230 can operate under the highest permissible power levels within a given regulatory framework and can require Automated Frequency Coordination (AFC) to avoid interference with incumbent systems. These devices can include desktop systems, enterprise workstations, home entertainment consoles, and automotive client devices such as connected vehicles or onboard telematics systems. The AP 102 may direct these devices to operate on spatially or spectrally isolated channels, leveraging beamforming and transmit power control to ensure coexistence with lower-power clients. The AP 102 may further optimize its overall coverage by selectively reassigning devices between BSSs, based on real-time environmental measurements, user density, or application-layer demands.

Across all device groups, the AP 102 can encapsulate power class information in the PHY layer of transmitted protocol data units (PPDUs), allowing for targeted link adaptation and regulatory compliance. Control mechanisms within the AP 102 may include class-specific contention windows, traffic prioritization rules, and interference mitigation schemes tailored to each power category. In some examples, the AP 102 may maintain a spatial representation of the coverage area, integrating environmental data such as physical obstacles, client distribution, and signal propagation characteristics. This spatial model can enable the AP 102 to simulate coverage zones, predict congestion areas, and recommend optimal client placement or AP 102 configuration updates.

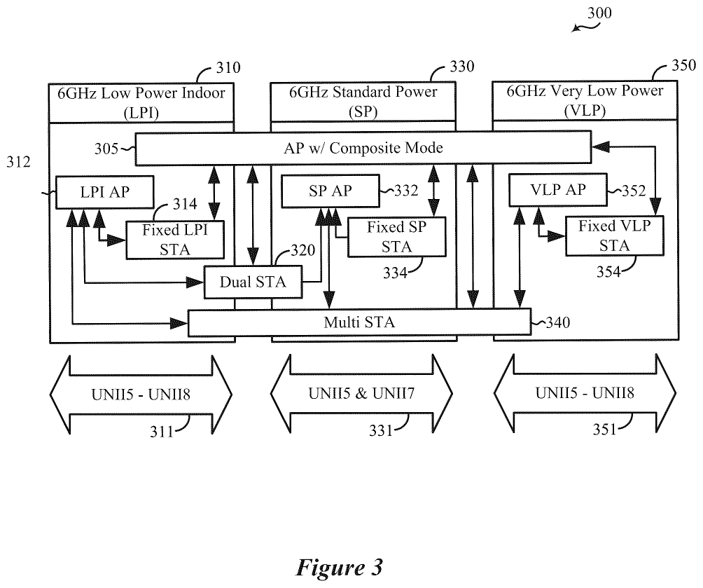

FIG. 3 illustrates an example wireless communication system 300 that enables AP coordination and client station (STA) operation across multiple 6 GHz regulatory power classes, namely LPI 310, SP 330, and VLP 350 device classes. In this example, the AP 305 operates in a composite mode, allowing it to manage simultaneous connectivity with client devices operating in any of the power classes. Conversely, the segmented access point entities, LPI AP 312, SP AP 332, and VLP AP 352, each separately configured to serve devices within its respective regulatory domain using the associated transmitting power limits and regulatory constraints.

The composite mode AP 305 differs from the segmented access point entities, LPI AP 312, SP AP 332, and VLP AP 352, by functioning as a centralized and unified AP that internally coordinates across all three power domains. While fixed APs are individually configured to serve devices within a specific regulatory domain using associated transmit power limits and constraints, the composite mode AP 305 can maintain separate BSSIDs for each domain, allowing it to serve multiple client device classes simultaneously. In some examples, the composite mode AP 305 can leverage internal scheduling mechanisms to manage frame transmissions and optimize coexistence, power-domain prioritization, and load balancing.

Within the LPI 310, the LPI AP 312 is responsible for managing communication sessions with a STA 314. These communication links are confined to the UNII-5 through UNII-8 frequency bands (represented by band segment 311) and utilize power-limited transmissions suitable for indoor-only operation. The LPI AP 312 supports traditional association and data path flows to and from the fixed LPI STA 314, and exchanges control frames such as beacons, probe responses, and authentication frames to establish and maintain connectivity.

Similarly, the SP domain 330 includes a corresponding SP AP 332, which is capable of operating under the regulatory framework applicable to standard power transmissions in the 6 GHz band. In this example, the SP AP 332 interacts with a fixed SP STA 334 through channels in the UNII-5 and UNII-7 frequency ranges (band segment 331). Communication pathways between the SP AP 332 and the fixed SP STA 334 can involve traditional uplink and downlink frame exchanges but also may include frequency coordination exchanges or AFC-mediated configuration updates where applicable. SP STAs can reside in outdoor or semi-outdoor environments, including automotive systems, and are subject to more stringent frequency coordination policies to protect incumbent users.

The VLP domain 350 includes a dedicated VLP AP 352, which supports communication with a fixed VLP STA 354 across the UNII-5 to UNII-8 frequency ranges (band segment 351), using the lowest power class permissible in 6 GHz operation. Depending on the jurisdiction, the VLP AP 352 operates under more restrictive propagation assumptions and may implement shorter-range beaconing, low-duty-cycle scheduling, or listen-before-talk (LBT) mechanisms. The VLP AP 352 can facilitate bi-directional traffic with the fixed VLP STA 354, exchanging both management and data frames in a power-constrained communication profile optimized for wearable and battery-sensitive device types.

Positioned between the LPI AP 312 and SP AP 332 is a dual-capable client device, the Dual STA 320. The Dual STA 320 can operate in either the LPI or SP domain but not concurrently. The communication pathways for the Dual STA 320 include separate association flows with each of the LPI AP 312 and SP AP 332, depending on the active power mode. The device can transition between these modes based on environmental triggers, such as channel quality degradation, mobility detection, or a change in operating environment from indoor to outdoor. When connected to the LPI AP 312, the Dual STA 320 exchanges frames across UNII-5 to UNII-8. When connected to the SP AP 332, the Dual STA 320 switches to SP-compliant operation in the UNII-5 or UNII-7 band. Mode switching may require de-authentication from one AP entity and reassociation with the other or may be facilitated via fast transition procedures if supported by the composite-mode AP 305.

The wireless communication system 300 also includes a Multi STA 340 that interfaces with all three AP entities: LPI AP 312, SP AP 332, and VLP AP 352. The Multi STA 340 is configurable or configured with the hardware and protocol stack support necessary for alternating operation across all three power domains. The communication pathways include parallel associations with each AP entity, where the Multi STA 340 can transmit and receive data frames on multiple frequency segments according to the regulatory restrictions of each domain.

At the base of the figure, each domain is annotated with its respective UNII band mappings. The LPI AP 312 and VLP AP 352 operate across the UNII-5 through UNII-8 bands (311 and 351), reflecting the indoor-only and very low power allowances across the broader 6 GHz spectrum. The SP AP 332 is restricted to the UNII-5 and UNII-7 bands (331), consistent with regulatory requirements for standard power devices that require automated frequency coordination. These band assignments influence not only the available channels for communication but also the coexistence and scheduling strategies enforced by the composite mode AP 305.

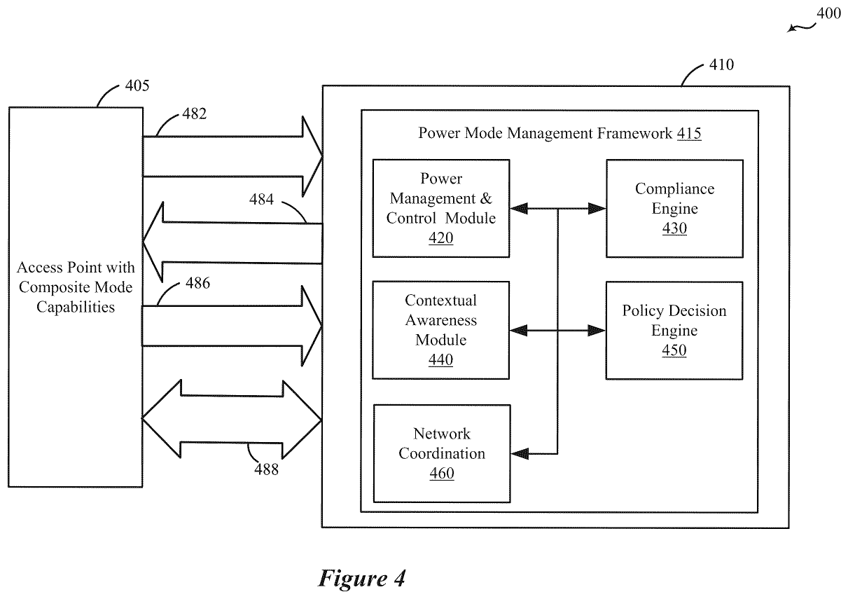

FIG. 4 shows a pictorial diagram of an example wireless communication system 400 that supports power mode switching at a wireless communication device 410 while maintaining an association with an AP 405 having composite mode capabilities. In some examples, the wireless communication system 400 includes the wireless communication device 410 in a network, such as the wireless communication network 100, described with reference to FIG. 1, and the wireless communication environment 200, described with reference to FIG. 2. In some examples, the AP 405 is similar to the AP 305 and the wireless communication device 410 is similar to the multi-STA 340, described with reference to FIG. 3. For example, the AP 405 may operate in composite mode allowing the AP to coordinate across all three power domains (LPI, SP, VLP) and may concurrently support communication sessions in each domain.

In some examples, the wireless communication device 410 may include a power mode management framework 415 that provides traffic flows 482, 484, 486, and 488 to a power management and control module 420 for managing power mode operations on the wireless communication device 410. In some examples, the power mode management framework 415 provides the traffic flows 482, 484, 486, and 488 over a network connection, such as a Wi-Fi connection or other similar connection, to the AP 405. In some examples, the AP 405 directly provides the traffic flows 482, 484, 486, and 488 to the power management and control module 420.

In some examples, the power mode management framework 415 facilitates dynamic transitions between different regulatory transmission power modes supported in a 6 GHz communication environment. For example, the power mode management framework 415 is instantiated on the wireless communication device 410 and interacts with the composite-mode AP 405, which can support multiple regulatory operating classes. The power mode management framework 415 may include a control architecture that enables power mode selection and in-session switching without requiring reassociation with the AP 405. As an example, the power mode management framework 415 may include a power management and control (PMC) module 420 configurable to monitor operating conditions and initiate mode transitions through action frames. These action frames may include regulatory information elements corresponding to the requested power class (such as Reg Info 0 for LPI, Reg Info 1 for SP, Reg Info 2 for VLP) along with power bounds defined by the minimum and maximum transmission power levels permitted by the applicable jurisdiction.

In some examples, the power mode management framework 415 also may include a compliance engine 430 configurable to enforce conformance with regional transmission regulations and SAR constraints. For example, if a user moves outdoors, the compliance engine 430 may evaluate whether a transition from LPI to VLP is permitted and suppress mode change requests that would violate policy or thermal safety thresholds.

In some examples, the compliance engine 430 may maintain an active compliance database including country-specific spectrum allocation rules, maximum transmit power values for each operating class (such as LPI, VLP, SP), and safety thresholds such as SAR limits applicable to the form factor and usage mode of the client device. For example, the compliance engine 430 may prevent a client device from switching into SP mode when operating in an outdoor scenario where SP is prohibited or when thermal or SAR limits for the device class (such as a smart watch, XR headset, or automotive communication systems like telematics units or in-vehicle infotainment systems, etc.) would be violated.

In some examples, the compliance engine 430 operates in conjunction with contextual data inputs received from sensors (such as a GPS, an accelerometer, a thermal sensor, etc.) and application-layer signals to assess whether a proposed power mode change is permissible. Upon receiving a proposed transition request from the policy decision engine 450, the compliance engine 430 can validate the request by comparing the target power mode's constraints, including regulatory region ID, transmit power bounds (minimum and maximum), and environmental suitability, against current device conditions and jurisdictional rules. If the requested mode violates a defined rule, the compliance engine 430 can block the transition and may generate a feedback signal indicating the constraint or reason for rejection.

In some examples, the compliance engine 430 can adapt its enforcement behavior based on updates received from over-the-air (OTA) management frames, firmware configuration profiles, or remote policy updates pushed from an enterprise network. In some examples, it may map regulatory info values (such as Reg Info 0 for LPI, Reg Info 1 for SP, Reg Info 2 for VLP, Reg Info 8 for Composite) to their respective rule sets and ensure the encoded parameters in outgoing power mode action frames are compliant prior to transmission. This validation can ensure that action frames sent to the AP 405 do not advertise an unsupported or unauthorized configuration.

In some examples, the compliance engine 430 also may implement a temporal gating function, preventing rapid toggling between modes that could otherwise trigger instability or exceed allowable duty cycles. The compliance engine 430 also can operate in a stealth mode, allowing power mode switching behavior not externally broadcast via standard beacons or probe responses, preserving the transparency of operation as outlined in regulatory guidelines and internal diagnostics requirements.

The power mode management framework 415 also may include a contextual awareness module 440 configured to detect operational triggers such as thermal readings, location changes, or application usage that indicate the need to switch modes. In some examples, the contextual awareness module 440 also may support integration with user-level preferences or enterprise-defined power policies.

In some examples, the power mode management framework 415 includes a contextual awareness module 440 that can monitor device-specific, environmental, and operational context to inform decisions related to power mode switching. The contextual awareness module 440 may receive inputs from one or more onboard sensors and subsystems, including but not limited to GPS receivers, gyroscopes, accelerometers, thermistors, user interface states (such as screen on/off), network stack indicators, and application-level activity profiles. These inputs can allow the contextual awareness module 440 to infer whether the client device is operating indoors versus outdoors, whether stationary or in motion, and whether it is engaged in latency-sensitive or high-throughput applications.

In some examples, the contextual awareness module 440 may detect when a device transitions from an indoor to an outdoor environment (such as based on geolocation change, signal attenuation patterns, or ambient light sensors) and trigger a recommendation to switch from LPI mode to VLP mode, as may be required by regulatory policy. In another example, thermal events such as skin temperature threshold breaches or rising internal heat profiles may prompt the module to downgrade the transmission mode from SP to LPI or VLP to maintain safe operating conditions and extend battery life.

In some examples, the contextual awareness module 440 also may interface with user-driven policies or enterprise-defined operating rules to inform mode selection. For example, when the wireless communication device 410 detects that a video conferencing application has become active and the user is stationary in a temperature-controlled environment, the contextual awareness module 440 may recommend elevating the power mode to SP to ensure consistent throughput. In contrast, while the screen is off and the user is mobile, the module may prioritize energy efficiency and suggest switching to VLP for background synchronization tasks.

In some examples, the contextual awareness module 440 may periodically report its status and contextual interpretation to the policy decision engine 450, which can synthesize this data with regulatory inputs to finalize mode transition decisions. In some examples, the contextual awareness module 440 may operate with configurable thresholds and tunable sensitivity levels, allowing OEMs or administrators to calibrate its behavior for different product categories such as smartphones, tablets, XR headsets, or wearable devices.

In some examples, the power mode management framework 415 includes a policy decision engine 450 that can arbitrate among multiple dynamic inputs, such as regulatory limits, contextual status, thermal readings, and application activity, to determine an optimal power mode operation at any given time. The policy decision engine 450 may implement a combination of static rulesets, hierarchical decision trees, and dynamic policy logic, optionally enhanced through machine learning models or real-time inference algorithms.

The policy decision engine 450 can receive validated regulatory constraints from the compliance engine 430 and environmental context signals from the contextual awareness module 440. It can then prioritize these inputs based on predefined weighting schemes, safety rules, and user preferences. For example, if both SP and VLP modes are available, the engine may evaluate whether the client device's current application profile and thermal state support a transition to SP for performance optimization or whether a transition to VLP is required to satisfy power or SAR constraints.

In some examples, the policy decision engine 450 may be configured with enterprise-or carrier-defined override policies, enabling it to suppress SP transitions in mobile form factors or in shared-spectrum environments subject to additional constraints. The policy decision engine 450 also may incorporate adaptive behavior, where it learns optimal transition patterns over time based on historical usage trends, success/failure rates of past transitions, or network-reported feedback.

When a power mode transition is deemed appropriate, the policy decision engine 450 can pass the decision to the power management and control module 420, including the selected regulatory info value, target transmission parameters, and any auxiliary metadata. The policy decision engine 450 also may ensure that transitions do not occur too frequently or under ambiguous contexts, reducing churn and preserving radio stability.

In some examples, the power mode management framework 415 includes a network coordination module 460 that can manage dynamic signaling, synchronization, and negotiation with the AP 405 that supports composite power mode operation. The network coordination module 460 may ensure that transitions between LPI, VLP, and SP modes occur in a manner that preserves Quality of Service (QoS), minimizes disruption to ongoing sessions, and adheres to coexistence and contention policies.

In some examples, the network coordination module 460 can monitor ongoing traffic conditions, beacon intervals, traffic indication map (TIM) fields, and channel utilization metrics broadcast by the AP 405. The network coordination module 460 may interpret this network state information to determine if a pending power mode switch would be acceptable given the AP's current scheduling strategy, BSS load, or channel occupancy. For example, if a channel is congested or the AP 405 is engaged in servicing multiple VLP devices on narrowband allocations, the network coordination module 460 may delay or reprioritize a proposed transition to a higher power mode such as SP to prevent collisions or service degradation.

In some examples, the network coordination module 460 can participate in the handshake sequence required for power mode transitions. This may include formatting and transmitting a power mode action frame that identifies the intended operating class (such as Reg Info 0 for LPI, Reg Info 1 for SP, Reg Info 2 for VLP) along with any required constraints such as maximum EIRP, duty cycle preferences, or latency sensitivities. Upon acknowledgment from the AP 405, the network coordination module 460 can synchronize the client device's radio parameters, such as modulation settings, transmit power tables, or channel bonding configurations, to match the updated mode profile.

In the example wireless communication system 400, the dynamic power mode switching procedure between the wireless communication device 410 and the AP 405 supporting composite mode operation is orchestrated through a coordinated series of transmission flows 482, 484, 486, and 488, as illustrated in FIG. 4. The procedure can begin with the AP 405 broadcasting beacon frames (traffic flow 482) that advertise its capability to operate in composite power mode, indicating support for multiple regulatory operating classes, including LPI, SP, VLP. These beacons may include regulatory information elements (such as Reg Info 8) and can be received by the network coordination module 460 of the wireless communication device 410, which can parse the advertised capabilities and relay the information to the power management and control module 420 and policy decision engine 450.

In some examples, the composite-mode AP 405 may advertise its support for dynamic power mode switching by including a composite mode capability indicator in its beacon frames, as part of traffic flow 482. This indicator may be implemented using a dedicated bit field in an extended capabilities information element or through a vendor-specific tag. Upon receiving a beacon frame containing this indicator, the wireless communication device 410 may indicate that the AP 405 supports in-session power mode switching across regulatory domains such as LPI, VLP, and SP. Based on this determination, the wireless communication device 410 may include, in the subsequent association request frame (traffic flow 484), a capability indication identifying that it also supports dynamic power mode transitions. The negotiation can allow the wireless communication device 410 and AP 405 to coordinate power mode changes without requiring disassociation or full reassociation, thereby enabling seamless transitions during an active session.

In response, when a change in operating conditions is detected, such as a transition to an outdoor environment or an application requiring higher throughput, the contextual awareness module 440 can gather sensor inputs (such as from a GPS, a thermal sensor, a motion sensor, etc.), and the policy decision engine 450 synthesizes this information with regulatory data supplied by the compliance engine 430. If the decision to initiate a power mode switch is validated, the power management and control module 420 can provide a reassociation request frame (traffic flow 484) that includes an indication of the client's support for dynamic 6 GHz power mode switching. This request is transmitted to the AP 405 and may include additional information elements that define power switching capabilities and indicate the client's intent to transition operating classes during an active session.

The AP 405 can process the request and responds with an acknowledgment or association response frame (traffic flow 486) that confirms support for composite mode and enumerates the allowed operating classes. Upon receipt, the power management and control module 420 can confirm readiness to switch power modes and sends a power mode action frame, encoded with the new regulatory info value (such as Reg Info 1 for SP) and accompanying parameters such as minimum and maximum transmit power. The compliance engine 430 can ensure that the values embedded in the frame comply with applicable regional rules and device SAR thresholds.

Following successful negotiation, transmission traffic resumes (traffic flow 488) under the new power mode configuration, with all subsequent management and data frames aligned to the selected operating class. The radio subsystem of the wireless communication device 410 may reconfigure physical layer parameters such as output power, channel bonding width, and modulation schemes to align with the updated power profile.

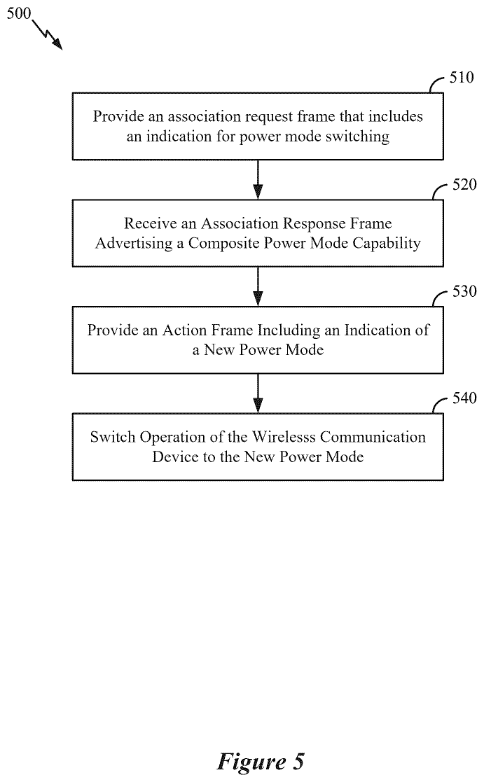

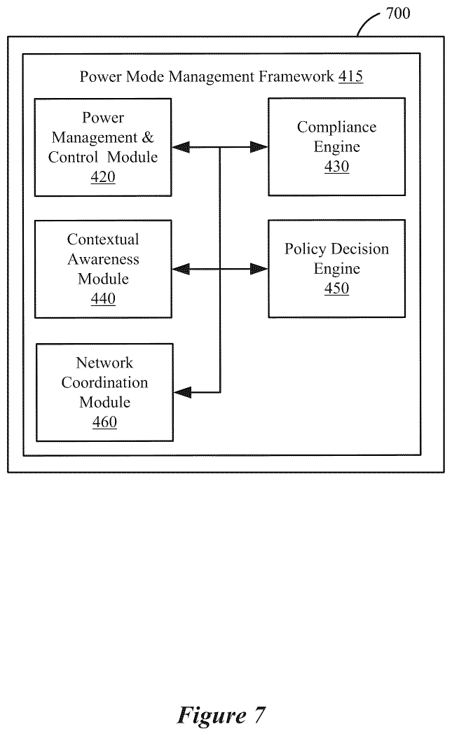

FIG. 5 illustrates an example flowchart depicting an example process 500 performable by or at a wireless communication device that supports dynamic power mode switching while maintaining an association with an AP. The operations of the process 500 may be implemented by a wireless communication device or its components described herein. For example, the process 500 may be performed by a wireless communication device, such as the wireless communication device 700 described with reference to FIG. 7, operating within a wireless AP, a wireless STA or other wireless communication device. In some examples, the process 500 may be performed by a wireless AP, such as one of the APs 102, or the wireless STA, such as one of the STAs 104 described with reference to FIG. 1. In some examples, the process 500 also may be performed by a wireless communication device such as the wireless communication device 410 with reference to FIG. 4.

In some examples, at block 510, the wireless communication device provides an association request frame that includes an indication that the device supports dynamic power mode switching. The indication may be embedded within a capability information element or through a vendor-specific extension. In some examples, the frame can be generated by the power management and control module 420 and provided under coordination with the network coordination module 460, which also may manage scan results or prioritize candidate APs based on support for composite mode operation. The inclusion of this indication can enable the AP to respond appropriately, signaling its own support for composite mode capabilities and establishing the foundation for subsequent over-the-air power mode transitions.

In some examples, at block 520, the wireless communication device receives an association response frame from the AP, which advertises its composite power mode capability. This response may include specific identifiers or bit fields indicating that the AP can support continued association with stations that dynamically transition between power modes. In some examples, the compliance engine 430 within the power mode management framework 415 can evaluate the received capabilities to verify that the advertised power modes are permissible under the current regulatory domain and that the device is authorized to operate in those modes. If compatibility is confirmed, the association enables subsequent dynamic coordination of power modes without disconnection and reassociation.

In some examples, at block 530, the wireless communication device provides an action frame to the AP, which includes an indication of the selected new power mode. In some examples, the action frame also may include operational constraints (such as reduced transmit power or limited channel usage) that are specific to the new power mode. The AP, upon receiving the frame, can update its internal session parameters for the device accordingly without requiring reassociation or renegotiation of the link. As an example, the contextual awareness module 440 can gather telemetry data, such as device location, motion state, proximity to the AP, or external conditions (such as a temperature or building structure), and provide it to the policy decision engine 450. Based on this input and the applicable operational policies, the policy decision engine 450 can select a target power mode and instruct the power management and control module 420 to initiate a transition request.

In some examples, at block 540, the wireless communication device switches operation to the new power mode. The power management and control module 420 can apply the new transmission parameters, adjust the RF front end, and configure MAC and PHY layer behavior consistent with the selected power mode's regulatory requirements. The compliance engine 430 can verify that the new configuration addresses applicable regional and safety constraints, such as EIRP limits or duty cycle requirements. The network coordination module 460 also can maintain session continuity and ensure that the device's ongoing communication with the AP remains stable and synchronized throughout the transition. Because the switching operation is handled entirely over the air, the device is able to maintain a seamless data session, enabling greater adaptability in dynamic environments, reduced latency during transitions, and improved user experience across heterogeneous network conditions.

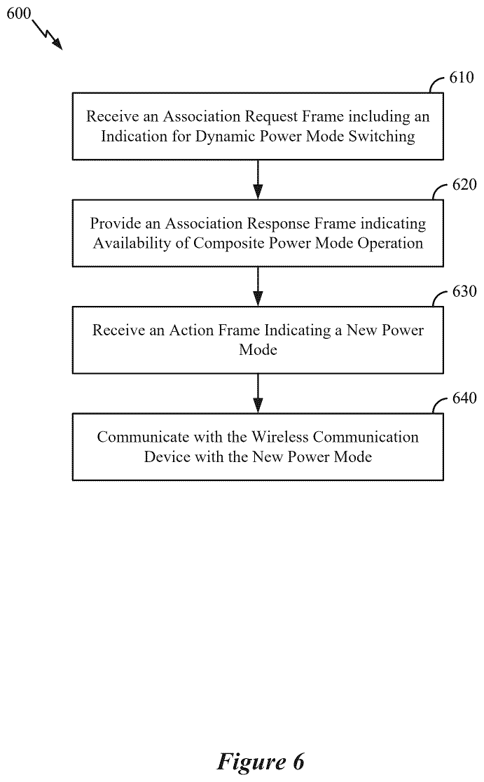

FIG. 6 illustrates an example flowchart depicting an example process 600 performable by or at a wireless communication device that supports facilitating dynamic power mode switching while maintaining an association with another wireless communication device. The operations of the process 600 may be implemented by a wireless communication device or its components as described herein. For example, the process 600 may be performed by a wireless communication device, such as the wireless communication device 700 described with reference to FIG. 7, operating within a wireless AP, a wireless STA or other wireless communication device. In some examples, the process 600 may be performed by a wireless AP such as one of the APs 102 or the wireless STA such as one of the STAs 104 described with reference to FIG. 1. In some examples, the process 600 also may be performed by an AP such as the AP 405 with reference to FIG. 4.

In some examples, at block 610, the wireless communication device receives an association request frame from another wireless communication device. This frame includes an indication that the device supports dynamic power mode switching that can be conveyed through a capability information element, vendor-specific field, or extension tag within the association request. Upon receiving this indication, the wireless communication device can identify the device as capable of performing in-session transitions between power modes and can flag the association context accordingly. In some implementations, the wireless communication device may maintain a per-client record indicating power mode flexibility, which allows the wireless communication device to apply custom handling during MAC-level scheduling and channel access arbitration.

In some examples, at block 620, the wireless communication device responds by providing an association response frame that indicates that composite power mode operation is supported and available. The response can inform the other wireless communication device that it may request transitions to different power modes during the lifetime of the association without requiring a reassociation sequence. In some examples, the wireless communication device may include additional information in the response, such as supported power modes, regulatory region parameters, or vendor-specific guidance. The response can establish the capability context needed to enable dynamic transitions.

In some examples, at block 630, the wireless communication device receives an action frame from the other wireless communication device, indicating the newly selected power mode. This action frame may include the new power class (such as SP, LPI, or VLP) and may optionally include accompanying constraints, such as maximum EIRP or duty cycle restrictions, associated with that mode. In some examples, upon receipt, the wireless communication device can update the client session state to reflect the other wireless communication device's new power mode. This may include adjusting link adaptation parameters, reconfiguring spatial stream expectations, updating transmit opportunity handling, and modifying medium access fairness algorithms to ensure compliance with power mode-specific behaviors. In some examples, the action frame is received after the other wireless communication device has completed its association and selection to switch power modes based on its internal context.

In some examples, at block 640, the wireless communication device communicates with the other wireless communication device using the new power mode. No reassociation or authentication is necessary. The transition does not require reassociation from the perspective of both the wireless communication device and the other wireless communication device. The wireless communication device may adapt downstream transmissions accordingly, ensuring that power-sensitive delivery mechanisms such as Target Wake Time (TWT), buffered traffic handling, or multi-user scheduling reflect the other wireless communication device's updated power capabilities. In some implementations, the wireless communication device also may log the power mode transition for telemetry or regulatory auditing purposes.

FIG. 7 shows an example block diagram of an example wireless communication device 700 that supports dynamic power mode switching while maintaining an association with an AP. In some examples, the wireless communication device 700 is configured to perform the processes 500 and 600 described, respectively, with reference to FIGS. 5 and 6. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 700 may transmit the information output from the chip. In such an example, the second interface may refer to an interface between the processing system of the chip and a reception component, such that the device 700 may receive information that is passed to the processing system. In some such examples, the first interface also may obtain information, such as from the transmission component, and the second interface also may output information, such as to the reception component.

The processing system includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more multiple antennas. In some implementations, one or more processors of the processing system include or implement one or more of the radios, RF chains or transceivers.

In some examples, the wireless communication device 700 can be configurable or configured for use in a STA, such as the STA 104 described with reference to FIG. 1. In some other examples, the wireless communication device 700 can be a STA that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes a user interface (UI) (such as a touchscreen or keypad) and a display, which may be integrated with the UI to form a touchscreen display that is coupled with the processing system. In some examples, the wireless communication device 700 may further include one or more sensors such as, for example, one or more inertial sensors, accelerometers, temperature sensors, pressure sensors, or altitude sensors, that are coupled with the processing system. In some examples, the wireless communication device 700 further includes at least one external network interface coupled with the processing system that enables communication with a core network or backhaul network that enables the wireless communication device 700 to gain access to external networks including the Internet.

The wireless communication device 700 includes various components. The components may include a power mode management framework 415, a power management and control module 420, a compliance engine 430, a contextual awareness module 440, a policy decision engine 450, and a network coordination module 460. Portions of one or more of the components may be implemented at least in part in hardware or firmware. For example, the power mode management framework 415 may be implemented at least in part by a processor or a modem. In some examples, portions of one or more of the components may be implemented at least in part by a processor and software in the form of processor-executable code stored in a memory.

The power mode management framework 415 is configurable or configured to facilitate dynamic transmission power mode switching in a wireless communication device operating in a 6 GHz wireless communication environment. The power mode management framework 415 is configurable or configured to orchestrate power mode transitions between LPI, SP, and VLP modes without requiring disassociation from an associated AP. The power mode management framework 415 is further configurable or configured to collect and interpret contextual, compliance, policy, and network state information from internal components of the wireless communication device to determine an appropriate target power mode. The power mode management framework 415 is also configurable or configured to generate, process, and transmit management frames, including action frames with regulatory information and transmission constraints, and to coordinate with an AP that advertises composite mode capability.

The power management and control module 420 is configurable or configured to execute transitions between supported power modes by generating corresponding action frames and applying updated transmission parameters to the wireless communication device's radio subsystem. The power management and control module 420 is further configurable or configured to manage the device's current power mode state and initiate updates in response to decisions made by the policy decision engine 450. The power management and control module 420 is also configurable or configured to reconfigure physical (PHY) and medium access control (MAC) layer parameters such as transmission power level, modulation coding scheme, and duty cycle based on the selected mode. The power management and control module 420 is further configurable or configured to apply device-specific constraints and hardware reconfiguration logic while ensuring that active communication sessions are maintained without interruption.

The compliance engine 430 is configurable or configured to validate proposed power mode transitions against regulatory constraints and safety limits such as SAR thresholds. The compliance engine 430 is further configurable or configured to maintain an active ruleset containing country-specific frequency allocations, transmit power limits, and thermal compliance policies. The compliance engine 430 is also configurable or configured to analyze environmental and device-specific factors, such as whether the device is operating indoors or outdoors, and prevent transitions to disallowed power modes. The compliance engine 430 is further configurable or configured to validate regulatory information encoded in outgoing action frames and suppress invalid or unsafe power mode transitions. In some implementations, the compliance engine 430 is configurable or configured to support dynamic updates based on over-the-air configuration changes or enterprise-pushed policy rules.

The contextual awareness module 440 is configurable or configured to monitor sensor inputs and operational context to select a change in power mode. The contextual awareness module 440 is further configurable or configured to receive inputs from onboard sensors, including GPS, motion detectors, thermistors, and ambient light sensors, and derive inferences regarding the environment (such as indoor vs. outdoor, mobile vs. stationary). The contextual awareness module 440 is also configurable or configured to identify user activities and device usage patterns, such as video conferencing or background synchronization, and provide contextual triggers to the policy decision engine 450. The contextual awareness module 440 is further configurable or configured to support environmental classification and device state reporting to inform power mode optimization decisions in real time.

The policy decision engine 450 is configurable or configured to evaluate data from the compliance engine 430 and contextual awareness module 440 to select the optimal power mode for current operating conditions. The policy decision engine 450 is further configurable or configured to synthesize multiple inputs using rule-based logic, decision trees, or machine learning models to select an appropriate power class. The policy decision engine 450 is also configurable or configured to apply enterprise-defined or user-defined policy constraints to override or refine its decision logic. The policy decision engine 450 is further configurable or configured to prioritize safety, performance, and battery efficiency and generate validated power mode change requests for execution by the power management and control module 420.

The network coordination module 460 is configurable or configured to manage communication and synchronization between the wireless communication device and a composite-capable access point (AP) during dynamic power mode transitions. The network coordination module 460 is further configurable or configured to parse beacon frames and management frames from the AP to identify support for composite power mode operation and retrieve corresponding regulatory capability information. The network coordination module 460 is also configurable or configured to format and transmit association request frames and power mode action frames that include regulatory information and transmission constraints. The network coordination module 460 is further configurable or configured to maintain session continuity, minimize disruption during mode transitions, and adjust transmission scheduling based on AP load, channel conditions, and QoS requirements.

Implementation examples are described in the following numbered clauses:
Clause 1. A wireless communication device, including: a processing system that includes one or more processors and one or more memories coupled with the one or more processors, the processing system configured to cause the wireless communication device to: provide an association request frame that includes an indication for power mode switching to an access point (AP) supporting composite power mode operation, receive an association response frame advertising a composite power mode capability from the AP, provide an action frame including an indication of a new power mode at the wireless communication device and associated transmission power constraints to the AP, and switch operation of the wireless communication device to the new power mode while maintaining an association with the AP.
Clause 2. The wireless communication device of clause 1, where the association request frame includes an information element (IE) that identifies the wireless communication device as supporting dynamic power mode switching.
Clause 3. The wireless communication device of any of clauses 1-2, where the association response frame includes one or more information fields respectively corresponding to a low power indoor (LPI) mode, a very low power (VLP) mode, and a standard power (SP) mode.
Clause 4. The wireless communication device of any of clauses 1-3, where the processing system is further configured to cause the wireless communication device to select the power mode using one or more operating conditions associated with the wireless communication device.
Clause 5. The wireless communication device of any of clauses 1-4, where the action frame further includes information enabling the AP to configure wireless communication parameters for the wireless communication device in accordance with the new power mode.
Clause 6. The wireless communication device of any of clauses 1-5, where the wireless communication device receives an indication of composite power mode capabilities of the AP in at least one beacon frame prior to providing the association request frame.
Clause 7. The wireless communication device of any of clauses 1-6, where the switch to the new power mode causes the wireless communication device to reconfigure one or more transmission parameters of a radio subsystem of the wireless communication device according to the associated transmission power constraints associated with the new power mode.
Clause 8. The wireless communication device of any of clauses 1-7, where the switch operation to the new power mode uses one or more operating conditions associated with compliance requirements for the wireless communication device.
Clause 9. The wireless communication device of any of clauses 1-8, where the one or more operating conditions include constraints associated with regulatory compliance requirements associated with the wireless communication device.
Clause 10. An access point (AP), including a processing system that includes one or more processors and one or more memories coupled with the one or more processors, the processing system configured to cause the AP to: receive, from a wireless communication device, an association request frame including an indication of support for dynamic power mode switching, provide an association response frame indicating availability of composite power mode operation, receive, from the wireless communication device, an action frame indicating a new power mode, and communicate with the wireless communication device in accordance with the new power mode while maintaining an association with the wireless communication device.
Clause 11. The AP of claim 10, where the indication of the composite power mode operation is provided in a beacon frame.
Clause 12. The AP of any of clauses 10-11, where the action frame includes information associated with regulatory compliance requirements or safety constraints of the wireless communication device.
Clause 13. The AP of clauses 10-12, where the composite power mode operation includes multiple power modes including at least a low power indoor (LPI) mode, a very low power (VLP) mode, and a standard power (SP) mode.
Clause 14. The AP of clauses 10-13, where the communication with the wireless communication device causes the AP to adjust transmit parameters in accordance with the new power mode.
Clause 15. The AP of clauses 10-14, where the action frame further includes one or more transmission constraints associated with the new power mode.
Clause 16. The AP of clauses 10-15, where the processing system is further configured to cause the AP to advertise, in one or more wireless management frames, an indication of support for the composite power mode operation including multiple power modes.
Clause 17. The AP of clauses 10-16, where the AP adjusts channel access parameters, modulation coding schemes, or spatial stream allocation based on the new power mode of the wireless communication device.
Clause 18. The AP of clauses 10-17, where the AP logs a power mode transition of the wireless communication device.
Clause 19. The AP of clauses 10-18, where the AP is configured to operate in a composite mode and maintain simultaneous basic service sets (BSSs) for the composite power mode operation.
Clause 20. An application client device, including a processing system that includes one or more processors and one or more memories coupled with the one or more processors, the processing system configured to cause the application client device to: provide an association request frame that includes an indication for power mode switching to an access point (AP) supporting composite power mode operation, receive an association response frame advertising a composite power mode capability from the AP, provide an action frame including an indication of a new power mode at the application client device and associated transmission power constraints to the AP, and switch operation of the application client device to the new power mode while maintaining an association with the AP.
Clause 21. A wireless communication device, including a means for providing an association request frame that includes an indication for power mode switching to an access point (AP) supporting composite power mode operation, a means for receiving an association response frame advertising a composite power mode capability from the AP, a means for providing an action frame including an indication of a new power mode at the wireless communication device and associated transmission power constraints to the AP, and means for switching operation of the wireless communication device to the new power mode while maintaining an association with the AP.
Clause 22. The wireless communication device of clause 21 in combination with the features of any of clauses 2-9.
Clause 23. A access point (AP), including a means for receiving, from a wireless communication device, an association request frame including an indication of support for dynamic power mode switching, a means for providing an association response frame indicating availability of composite power mode operation, a means for receiving, from the wireless communication device, an action frame indicating a new power mode, and a means for communicating with the wireless communication device in accordance with the new power mode while maintaining an association with the wireless communication device.
Clause 24. The AP of clause 23 in combination with the features of any of clauses 11-19.
Clause 25. A non-transitory processor-readable storage medium including processor-readable instructions configured to cause one or more processors to perform a process at a wireless communication device, including code for: providing an association request frame that includes an indication for power mode switching to an access point (AP) supporting composite power mode operation, receiving an association response frame advertising a composite power mode capability from the AP, providing an action frame including an indication of a new power mode at the wireless communication device and associated transmission power constraints to the AP, and switch operation of the wireless communication device to the new power mode while maintaining an association with the AP.
Clause 26. The non-transitory processor-readable storage medium of clause 25 in combination with the features of any of clauses 2-9.
Clause 27. A non-transitory processor-readable storage medium including processor-readable instructions configured to cause one or more processors to perform a process at an access point (AP), including code for: receiving, from a wireless communication device, an association request frame including an indication of support for dynamic power mode switching, providing an association response frame indicating availability of composite power mode operation, receiving, from the wireless communication device, an action frame indicating a new power mode, and communicating with the wireless communication device in accordance with the new power mode while maintaining an association with the wireless communication device.
Clause 28. The non-transitory processor-readable storage medium of clause 27 in combination with the features of any of clauses 11-19.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information) or accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communication device, comprising:
a processing system that includes one or more processors and one or more memories coupled with the one or more processors, the processing system configured to cause the wireless communication device to:
provide an association request frame that includes an indication for power mode switching to an access point (AP) supporting composite power mode operation;
receive an association response frame advertising a composite power mode capability from the AP;
provide an action frame including an indication of a new power mode at the wireless communication device and associated transmission power constraints to the AP; and
switch operation of the wireless communication device to the new power mode while maintaining an association with the AP.

2. The wireless communication device of claim 1, wherein the association request frame includes an information element (IE) that identifies the wireless communication device as supporting dynamic power mode switching.

3. The wireless communication device of claim 1, wherein the association response frame includes one or more information fields respectively corresponding to a low power indoor (LPI) mode, a very low power (VLP) mode, and a standard power (SP) mode.

4. The wireless communication device of claim 1, wherein the processing system is further configured to cause the wireless communication device to select the power mode using one or more operating conditions associated with the wireless communication device.

5. The wireless communication device of claim 1, wherein the action frame further includes information enabling the AP to configure wireless communication parameters for the wireless communication device in accordance with the new power mode.

6. The wireless communication device of claim 1, wherein the wireless communication device receives an indication of composite power mode capabilities of the AP in at least one beacon frame prior to providing the association request frame.

7. The wireless communication device of claim 1, wherein the switch to the new power mode causes the wireless communication device to reconfigure one or more transmission parameters of a radio subsystem of the wireless communication device according to the associated transmission power constraints associated with the new power mode.

8. The wireless communication device of claim 1, wherein the switch operation to the new power mode uses one or more operating conditions associated with compliance requirements for the wireless communication device.

9. The wireless communication device of claim 8, wherein the one or more operating conditions include constraints associated with regulatory compliance requirements associated with the wireless communication device.

10. An access point (AP), comprising:
a processing system that includes one or more processors and one or more memories coupled with the one or more processors, the processing system configured to cause the AP to:
receive, from a wireless communication device, an association request frame including an indication of support for dynamic power mode switching;
provide an association response frame indicating availability of composite power mode operation;
receive, from the wireless communication device, an action frame indicating a new power mode; and
communicate with the wireless communication device in accordance with the new power mode while maintaining an association with the wireless communication device.

11. The AP of claim 10, wherein the indication of the composite power mode operation is provided in a beacon frame.

12. The AP of claim 10, wherein the action frame includes information associated with regulatory compliance requirements or safety constraints of the wireless communication device.

13. The AP of claim 10, wherein the composite power mode operation includes multiple power modes including at least a low power indoor (LPI) mode, a very low power (VLP) mode, and a standard power (SP) mode.

14. The AP of claim 10, wherein the communication with the wireless communication device causes the AP to adjust transmit parameters in accordance with the new power mode.

15. The AP of claim 10, wherein the action frame further includes one or more transmission constraints associated with the new power mode.

16. The AP of claim 10, wherein the processing system is further configured to cause the AP to advertise, in one or more wireless management frames, an indication of support for the composite power mode operation including multiple power modes.

17. The AP of claim 10, wherein the AP adjusts channel access parameters, modulation coding schemes, or spatial stream allocation based on the new power mode of the wireless communication device.

18. The AP of claim 10, wherein the AP logs a power mode transition of the wireless communication device.

19. The AP of claim 10, wherein the AP is configured to operate in a composite mode and maintain simultaneous basic service sets (BSSs) for the composite power mode operation.

20. An application client device, comprising:
a processing system that includes one or more processors and one or more memories coupled with the one or more processors, the processing system configured to cause the application client device to:
provide an association request frame that includes an indication for power mode switching to an access point (AP) supporting composite power mode operation;
receive an association response frame advertising a composite power mode capability from the AP;
provide an action frame including an indication of a new power mode at the application client device and associated transmission power constraints to the AP; and
switch operation of the application client device to the new power mode while maintaining an association with the AP.
